(19) United States
(12) Patent Application Publication
(10) Pub. No.: US 2012/0174212 A1
(43) Pub. Date: Jul. 5, 2012

(54) CONNECTED ACCOUNT PROVIDER FOR MULTIPLE PERSONAL COMPUTERS

(75) Inventors: Scott Dart, Redmond, WA (US); Lindsey Noll, Bellevue, WA (US); Ari Pernick, Snoqualmie, WA (US); Ling Lu, Issaquah, WA (US); Kyle Beck, Redmond, WA (US); Chris Macaulay, Seattle, WA (US); Sean Gilmour, Issaquah, WA (US); David Perry, Lynnwood, WA (US); Sunil Gottumukkala, Redmond, WA (US); Ken Tubbs, Issaquah, WA (US); Anshul Rawat, Kirkland, WA (US); Sashi Raghupathy, Redmond, WA (US); Patrik Lundberg, Lake Forest Park, WA (US); Rajeev Dubey, Sammamish, WA (US); Sergio Dutra, Woodinville, WA (US); Edson Dos Santos, Renton, WA (US); Charles Aaron Hare, Woodinville, WA (US); Giles van der Bogert, Renton, WA (US)

(73) Assignee: MICROSOFT CORPORATION, Redmond, WA (US)

(21) Appl. No.: 12/980,520

(22) Filed: Dec. 29, 2010

(51) Int. Cl. G06F 15/16; G06F 21/00; H04L 9/32

(52) U.S. Cl. 726/19; 709/203

(57) ABSTRACT

A connected account provider system allows a user of multiple electronic devices to set up a user account on one device with the device's settings saved in the cloud for application across different devices. A user can obtain secure access to the saved settings using a second (or subsequent) device and can select settings from the initial device to be synchronized to the second device. The system employs client account provider (CAP) software that can be obtained from an independent software provider and is installed on different devices of a user. The CAP client software creates an architecture on a user's device with a CAP client software layer conceptually separate from the device's operating system software. The CAP client software provides extension points for facilitating connection between connected user devices' operating systems and a cloud services layer typically provided by the CAP client software vendor.

### BACKGROUND

Computer users typically have many settings personal to them. These can include login credentials (username and/or password), operating system settings, such as wallpaper, icons to be displayed on a desktop, accessibility options, access credentials for web-based services, and many others. Computer users often have multiple computers or other electronic devices resident in different locations or that they carry with them. If a user wants his or her computers and other devices to have the same “look and feel,” use the same login credentials, use the same credentials for logging in to other applications, websites and/or wireless networks, have the same operating system settings, etc., all of these features typically have had to be set manually on each computer or other device.

There have been attempts to link computers by using software that enables communications with online services. However, to a large degree these applications have been available only to enterprise users of centrally managed computers, and/or have been limited in their ability to coordinate all of the settings a user might want to duplicate from one computer to the next. They have also been somewhat cumbersome and difficult to use because known systems often require user or administrator to perform a somewhat lengthy setup procedure to synchronize settings from a first device to subsequent devices.

### SUMMARY

One aspect of the subject matter discussed herein provides a secure account that saves user settings in the cloud for access by multiple electronic devices of a single user. The connected account can be provided by connected account provider (CAP) client software obtained from an independent software vendor (ISV) and installed on a user's computer or other electronic device having operating system software already installed. Alternatively, the CAP client software and the device's operating system software can be provided by the same source. In the normal course, the vendor who provides the CAP client software will also provide the cloud layer services for supporting the connected accounts.

In another aspect, the CAP client software conceptually comprises a layer on a user device that is separate from the device operating system layer, and provides extension points that connect the operating system layer to the cloud services layer without requiring modifications to operating system software across multiple platforms.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The objects of the subject matter discussed herein will be better understood from the detailed description of embodiments which follows below, when taken in conjunction with the accompanying drawings, in which like numerals and letters refer to like features throughout. The following is a brief identification of the drawing figures used in the accompanying detailed description.

FIG. 1 is a schematic block diagram of an electronic device embodied by a computer system suitable for implementing the subject matter discussed herein.

FIG. 2 depicts an embodiment of a client account provider system architecture implemented using the computer system shown in FIG. 1.

FIG. 3 is a flowchart depicting one method of setting up a user account with associated settings for the electronic device in FIG. 1 using the system architecture depicted in FIG. 2.

FIG. 4 is a flowchart depicting one method of setting up a user account and synchronizing original settings to a second or subsequent device.

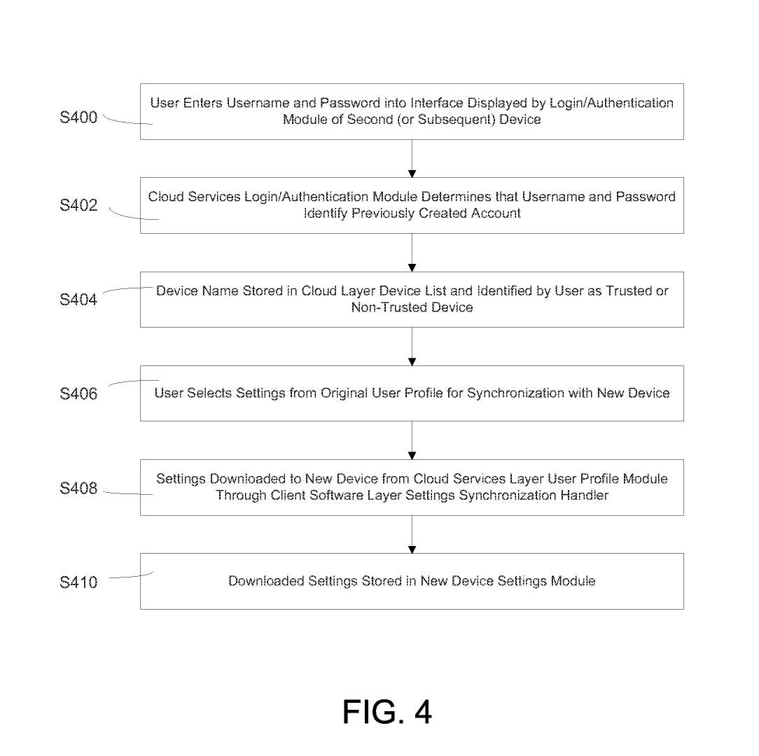

One skilled in the art will readily understand that the drawings are schematic in many respects, but nevertheless will find them sufficient, when taken with the detailed description that follows, to make and use the claimed subject matter.

### DETAILED DESCRIPTION

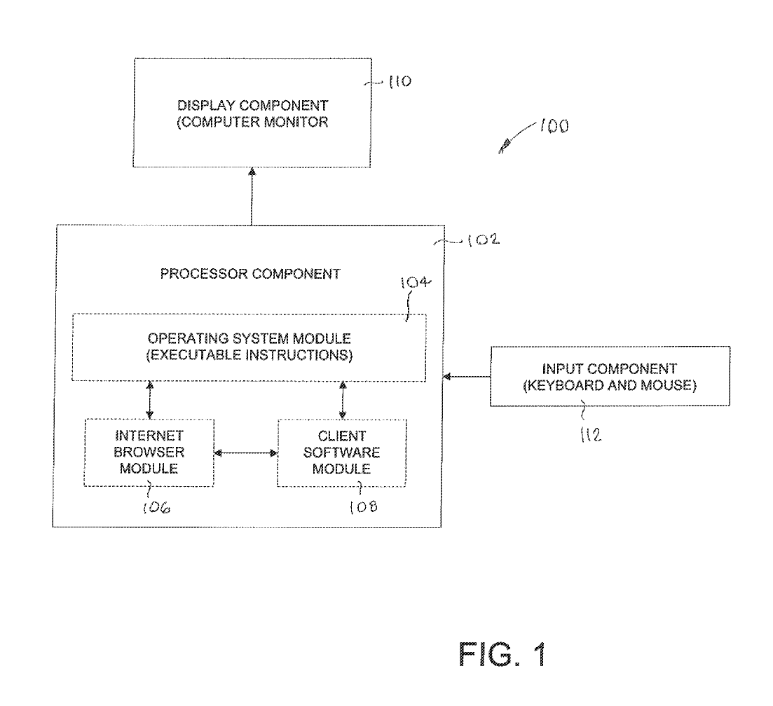

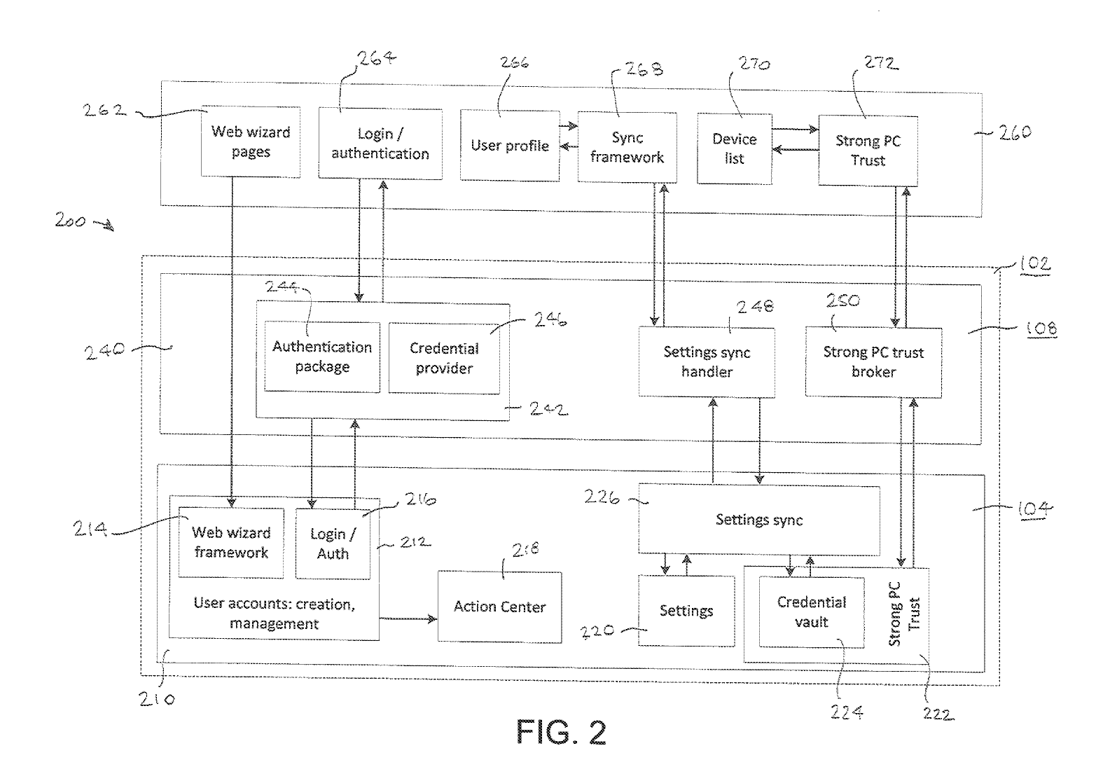

FIG. 1 schematically illustrates an electronic device embodied in the present description by a computer system 100 that can store information and executable instructions thereby to carry out the operations described herein. This exemplary computer system comprises a processor component 102 that includes an operating system module 104. The operating system module is typically stored on a non-transitory computer storage medium or device such as a hard drive (not shown), and is embodied in computer executable instructions that are executed by the processor component 102. The processor component also includes an Internet browser software module 106 or the like that enables a user of the computer system to access the Internet and/or another location or locations separate or remote from the computer system 100, sometimes referred to herein as “the cloud,” The processor component also includes a client software module 108 stored on the hard drive or on another storage device/computer storage media included in the system. The client software is described in more detail further below in connection with FIG. 2.

The computer system 100 further includes a display component 110, such as a computer monitor, and an input component 112, which in a typical implementation will comprise a conventional pointing device such as a mouse and a keyboard, although many other input components or apparatus could be used, such as a touch screen activated by a user's hand or a pen, voice commands, and the like. A typical operational paradigm for the computer system 100 involves a graphical user interface that is displayed on the display component 110 under the control of the operating system module 104. A user interacts with the graphical user interface using the input component 112 to enter commands to the operating system module 104 to execute instructions that initiate various actions, such as accessing the Internet via the browser module 106, launching applications, and otherwise controlling the operation of the computer system 100.

As used in this description, the terms “component,” “module,” “system,” “apparatus,” “interface,” or the like are generally intended to refer to a computer-related entity, either hardware, a combination of hardware and software, software, or software in execution, unless the context clearly indicates otherwise. For example, such a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer (device) and/or distributed between two or more computers (devices).

As used herein, a “computer storage medium” can be a volatile and non-volatile, removable and non-removable medium implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer

The computer system 100 described here is meant to be only one example of an electronic device with which the connected account provider described herein can be used. It is intended that “electronic device” be considered broadly as including any such device (or any physical or logical element of another device, either standing alone or included in still other devices) that is configured for communication via one or more communication networks to cloud services and that is responsive to user inputs. Examples of such electronic devices include, but are not limited to, mobile phones, personal digital assistants, smart phones, laptop and desktop computer systems of any configuration or implementation, personal media players, image or video capture/playback devices, devices temporarily or permanently mounted in transportation equipment such as planes, trains, or wheeled vehicles, set-top boxes, game consoles, stereos, digital video recorders/players, and televisions.

Furthermore, the subject matter described and claimed herein may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disc, floppy disc, magnetic strips), optical discs (e.g., compact disc (CD), digital versatile disc (DVD) . . . ), smart cards, and flash memory devices (e.g., card, stick, key drive . . . ). Of course, those skilled in the art will recognize many modifications may be made to this configuration without departing from the scope or spirit of the claimed subject matter.

A. CAP System Architecture

FIG. 2 depicts the architecture of a system, sometimes referred to herein as a connected account provider (CAP) system, for synchronizing information from one electronic device, such as the computer system shown in FIG. 1, to another. Conceptually, the CAP system of the illustrated embodiment includes three main layers, as it is shown in accompanying FIG. 2. The first layer 210 is considered part of the operating system module 104 depicted schematically in FIG. 1. It will be understood that a “module,” as used herein, and particularly in FIG. 2, is not necessarily, and typically is not, a physically separate component. The modules referred to in connection with FIG. 2 are to be understood in a broad sense as information in the form of executable instructions, storage locations, etc., that may be, and typically are, distributed across various locations in the storage media on which they reside.

The operating system layer 210 includes a user account creation/management module 212 that incorporates a web wizard framework module 214 and a login/authentication module 216. The user account creation/management module 212 communicates with an action center module 218, which is a feature of the operating system module that standardizes the manner in which system notifications are provided to the user. The action center module cooperates with the user account creation/management module 212 in a manner described further below. A settings module 220 stores settings of a user of the computer system 100 (FIG. 1). These settings can be properties that the user has chosen to personalize the manner in which his or her computer operates; examples of such settings are given further below. A trust module 222 includes a credential vault 224 that stores user credentials such as a username and password that uniquely identify a particular user, as well as other credentials of the user such as various ones he or she uses to log in to access different websites and other applications on the system. The settings module 220 and credential vault 224 communicate with a settings synchronization module 226 for a purpose described further below.

The second layer 240 comprises CAP client software that resides in the client software module 108 on the processor component 102 of the computer system 100 shown in FIG. 1. The system can be constructed with CAP client software supplied by an independent software vendor (ISV) to enable the user to create connected accounts among two or more computer systems or devices like the one shown in FIG. 1, or with CAP client software supplied by the operating system software provider. In either case, the second layer includes a user identification module 242 that comprises an authentication package module 244 and a credential provider module 246. The identification module 242 communicates with the login/authentication module 216 of the user account creation/management module 212 of layer 210. The interaction of these modules is described in more detail below. The CAP client software further comprises a settings synchronization handler module 248 that communicates with the settings synchronization module 226 of the first layer 210. The CAP client software comprising the second layer 210 further includes a trust broker module 250 that communicates with the operating system trust module 222 of the first layer 210, the purpose of which is also described further below.

The third CAP layer 260 comprises cloud services, which will usually be provided by the same ISV that supplies the CAP client software of the second layer 240. The cloud services modules described herein are provided by one or more server computers accessible by the processor component of the computer system 100 shown in FIG. 1, typically via its Internet browser module 106. The manner of connecting to the Internet using browser software is well known to those skilled in the art and need not be described in detail here. It will be appreciated that the cloud services can be embodied various combinations of communication networks other than the Internet, including any existing or future, public or private, wired or wireless, wide-area (“WANs”) or local-area (“LANs”), packet-switched or circuit-switched, one-way or two-way digital data transmission infrastructures or technologies. Exemplary networks include: the Internet, managed WANs (for example, cellular networks, satellite networks, fiber-optic networks, co-axial cable networks, hybrid networks, copper wire networks, and over-the-air broadcasting networks such as television, radio, and data casting networks), LANs (for example, wireless local area networks and personal area networks, or direct cable connections), and temporary networks created through the use of near field communication devices. It is also possible to connect to any of these repositories of cloud services other than through browser software.

The cloud services include a module 262 that communicates directly with the web wizard framework module 214 included in the operating system layer 210. The module 262 is termed a “web wizard pages module” in FIG. 2, but those skilled in the art will understand it in more general terms software causing the display on the device's display component 110 of an interface permitting the user to enter user credentials and other information. The term “wizard” is used according to its common meaning and as applied here refers to a series of web pages or other interfaces that guide a user through a multi-step process. It will be appreciated that the interaction between the user and the displayed web pages is via a mouse, keyboard, touch screen, microphone for accepting verbal inputs interpreted by voice-recognition software, or any other suitable input component. The process of creating (and managing) user accounts suing the web wizard is described in more detail below.

The CAP cloud services layer 260 also includes a login/authentication module 264 that communicates with the user identification module 242 included in the CAP client software comprising the second layer 240 on the computer system 100. The credential provider module 246 transmits user-created credentials to the module 264 for verification in accordance with the description further below. A user profile module 266 is included in the cloud services layer 260 and communicates with a synchronization framework module 268 to a purpose described below. The synchronization framework module 268 in turn communicates with the settings synchronization handler module 248 included in the second layer 240. The synchronization framework module 268 utilizes user profiles stored in the user profile module 266 to enable the synchronization of settings on different devices in a user's account. To that end, a list of “trusted” devices is stored in the module 270. A trusted device is one to which all settings in the user profile module 266 will automatically be applied according to the description below. Conversely, certain settings will not be permitted to synchronize with devices that are not trusted, although some settings may be synchronized with non-trusted devices anyway.

B. CAP System Functionality and Operation

This description assumes that the CAP client software has been loaded onto the hard drive or other storage media of the processor component 102 of the computer system 100 and is available to the user. As noted above, the CAP client software is usually provided by an independent software vendor who also provides the cloud services available on cloud service layer 260 of the CAP system described above. It will be appreciated that the CAP client software can be obtained by the user in a variety of ways. For example, the operating system vendor could provide the CAP client software with the operating system software, so that the CAP client software is installed on the processor upon installation of the operating system software. Alternatively, the CAP client software can be provided separately and installed by the user after the operating system software has been installed and the computer is fully functional. It will be appreciated that the operating system software is provided with the components of the first layer 210 of the CAP system architecture, but those components typically are not used unless CAP client software has been installed.

1. Setting Up a Connected Account

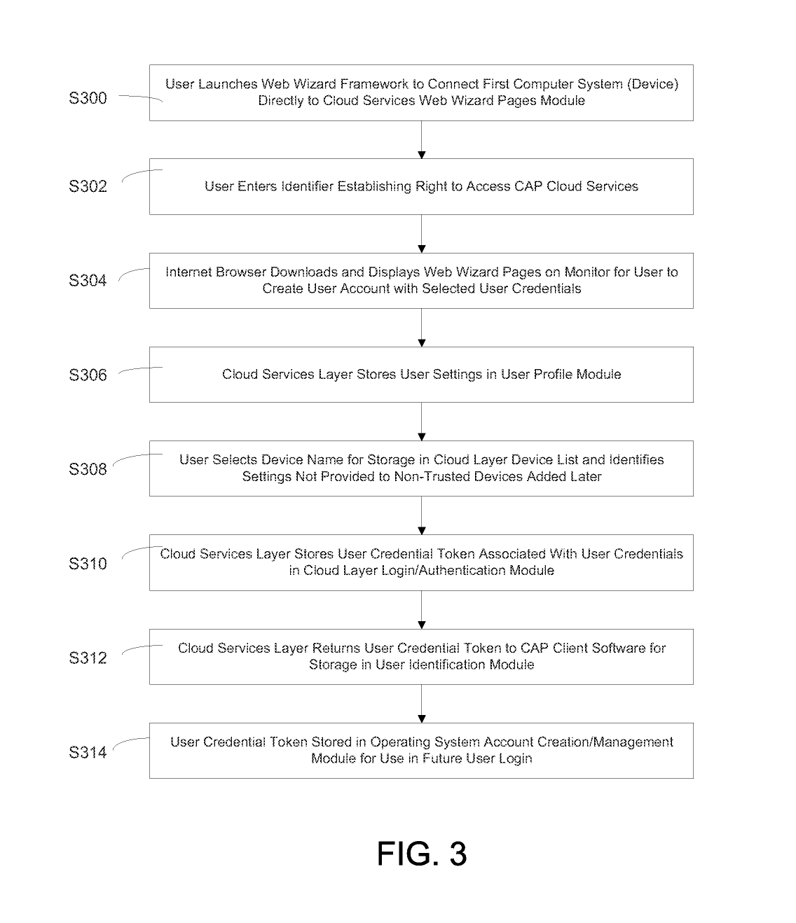

Once the CAP client software has been loaded, the user can set up an initial connected account using the web wizard framework module 214. FIG. 3 is a flowchart of a method by which the initial account is created. The account creation/management module 212 can be activated by the user using an input component as discussed above (such as a mouse) to launch the web wizard framework from an icon or menu item that activates the web wizard framework module 214. As noted above, this connects the processor component to the web wizard pages module 262 included in the cloud services layer 260 and guides the user through the process of creating an account. Step S302 indicates that once the computer system 100 is connected to the cloud services layer in this fashion, the web wizard pages module 262 causes the device to display an interface for the user to complete. For example, the initial set-up process could request entry of an identifier to verify that the user is entitled to access to the CAP system. Such an identifier can take the form of a unique certificate number provided with the CAP client software, but it will be appreciated that this identifier can take any form desired by the ISV providing the CAP client software and cloud services.

Once the user's right to use the cloud services provided, by the CAP software provider has been established, the web wizard framework module displays in step S304 an interface that can include various forms with blank fields the user can fill in using the keyboard input component and check boxes that can be selected using the mouse input component (or any other manner of inputting information, such as a touch screen or voice command). Of course, other input components such as those mentioned above can be used, as well. The forms gather information from the user that establishes an account with a particular user profile that is stored in the user profile module 266 in the CAP cloud services layer 260 for future access. The user profile will include user credentials that uniquely identify the user and the account and that will be securely held by the system as discussed in more detail below. For convenience of application, these user credentials typically comprise a username, typically the user's e-mail address for an e-mail account handled by the cloud service ISV and the password associated with that e-mail address. However, it will be appreciated that these user credentials can take any form that enables the cloud services layer to uniquely recognize individual user accounts. In short, the web wizard pages provide the information needed by the user account creation/management module 212 in the operating system software needed to set up a user account with the selected credentials. Accordingly, the web wizard framework module, by connecting to the cloud services layer to provide an interface that can be used to create a user account, functions as an extension point between the computer system (device) 100 and the cloud services layer 260. That is, special or customized software is not needed to initiate the set-up process and realize the functionality of the CAP system

It will be appreciated that the user account creation/management module 212 also displays an interface (not shown) by which the user can choose any settings or information that the user would like to have available in the cloud services layer 260 in the user profile module 266. For purposes of this discussion, the term “setting” refers broadly to any information relating to operational properties of the device. As examples, such operational settings can be a wallpaper displayed as a background on the computer monitor 110, the choice and placement on the monitor of icons (not shown) and other components of the graphical user interface with which the user interacts to control the operation of the computer system (such as launching programs or accessing web pages), accessibility options the user has chosen, a list of software applications installed on the computer system hard drive, usernames and passwords for various web sites and/or software applications, custom spell-check dictionaries, video game information (such as high score), video player progress or status, and any other information that the user anticipates needing at other devices he or she has access to. Note that “settings” as used herein also includes the user credentials that identify the user to the system. In any event, these are the same settings that are stored in the operating system layer 210 by the settings module 220.

The action center module 218 is a feature of the operating system software that provides notices to the user regarding matters that may need the user's attention or just as information items. In the present context, it cooperates with the user account creation/management module 212 in order to provide various notices to the user regarding the status of his or her connected account. For example, the user could be notified by a message displayed on the device monitor that his or her password may be compromised and should be changed, or that the particular device being used is not a “trusted” device (see above).

When the set-up information, including the operational information settings and user credentials, has been entered by the user, it is stored by the cloud layer user profile module 266 in step S306. In addition, the user chooses in step S308 an identifier for the computer system (device) 100 for storage in the device list 270 and indicates those settings that are not to be synchronized with non-trusted devices that may be subsequently added to the account as discussed below. Then, in step S310 the cloud services layer 260 generates a user credential token and stores it in the cloud layer login/authentication module 264. In step S312 the user credential token is downloaded to the CAP client software layer 240 and stored in the user identification module 242. This token is associated with the user account that was set up as discussed above. In step S314 the token is also stored in the user account creation/management module 212 in the operating system layer 210. The user can then log in to the computer system 100 and the login/authentication module 216 provides access to the cloud services layer through the user identification module 242 of the CAP client software layer 240. In this fashion, the user identification module 242 comprises another extension point between the computer system 100 and the cloud services layer 260. That is, the authentication package module 244 and the credential provider module 246 enable the operating system layer 210 to communicate directly with the cloud services layer 240 and access the features of the connected account provider. To that end, this extension point caches the user's credentials in the credential provider module 246 for provision to the login/authentication module 264 in the cloud services layer 260. Note that local storage of the user credential token may also permit validation of the user credentials even when there is no active connection to the cloud services layer 260. A comparable token is synchronized to other devices added to the account as explained in the next section.

2. Extending the Account to Other Devices

Other devices the user wants to include in his or her connected account will include the operating system layer 210 and the CAP client software layer 240 in a form corresponding to that shown in FIG. 2. The manner by which the user's information is synchronized to other devices is described in connection with the flowchart in FIG.

The user accesses the cloud services layer 260 with a second (or subsequent) device using the username and password established when he or she set up an account, as discussed above. This is shown in step S400, in which the user activates the second device's user account creation/management module 212 to display an interface provided by the login/authentication module 216, and then enters his or her account username and password. (This is also how the user accesses his or her account on the first device, once the account has been set up.) Once the user's username and password are recognized, a user credential token is provided to the second device as described above in connection with the original device. Then, as discussed above, the extension point provided by the user identification module 242 in the CAP client software layer 240 will enable the second device (and subsequent devices) to communicate with the cloud services layer 260 when the user logs in to the second device by entering his or her username and associated password. The login/authentication module 264 in the cloud services layer recognizes the information and permits the user to access his or her previously created connected account.

In step S402 the login/authentication module 264 in the cloud services layer 260 determines if the entered username and password match a previously created connected account. If so, the cloud service layer login/authentication module 264 provides an instruction to the CAP client software layer's user identification module 242 to permit the user access to the previously established account. In turn, the operating system software layer's user account creation/management module 212 displays an interface on the device's display component for entry by the user in step S404 of an identifying name for new device's name for storage in the cloud layer's device list module 270. Alternatively, the operating system could provide a name for the device based on an identification included in the device by its manufacturer, or the operating system could display a name it will give the device unless overridden by the user. In step 104 the user identifies whether or not the device list is to designate the device as a “trusted” device.

In Step 406, an interface is displayed for the user to choose any settings from the original account that he or she does not want to be downloaded from the user profile 266 in the cloud services layer 260 to the device being added to the account. In step S408, the settings from the original set up stored in the user profile module 266 in the cloud services layer are displayed in an appropriate interface on the new device's display component so the user can select which settings are to be applied to the new device. (For example, a user may want a different wallpaper on a connected smart phone than on other connected devices such as computers.) Next, in step S408, the settings synchronization handler module 248 in the CAP client software layer 240 functions as a third extension point between the operating system layer 210 of the new device and the cloud services layer 260 to synchronize the new device with the settings selected by the user in step S408. That is, the user profile settings that were created and stored in the user profile module 266, and selected for application to the new device, are downloaded by the settings synchronization handler module 218 and stored in step S410 in the settings module 220 in the operating system layer 210 of the new device. It will be appreciated that step S406 is optional, and in another embodiment the added device assumes all of the settings of the original device. The new device then stores these settings in its settings module 220 for use by the device's operating system module and software applications.

Access to a user's information from unauthorized computing devices is prevented, by providing a security scheme embodied in the various trust modules included in the system. There are many methods by which this can be accomplished. One uses as first user information the user's username and password and as second user information one or more password hints comprising facts that are normally known only to the user. Some examples of such password hints are the user's mother's maiden name, the user's favorite color, the town in which the user was born, etc. The cloud layer trust module 272 heuristic could be set up to regard certain login attempts as suspicious, requiring further confirmation beyond the first user information of username and password before being accepted as authentic. One such situation arises when a user has logged in to one computing device and another user logs in using another device in another city. In this case, the cloud services layer trust module may communicate with one or the other user (or both users) through the extension point provided by the client software trust broker 250 to cause a prompt to appear on the devices' displays (one or both devices) requesting input of one or more of the authorized user's password hints. This is identified as a “strong trust” relationship in FIG. 2, because it is very unlikely that a user's password hints could be known by someone else, even if his or her username and password have been compromised.

This strong trust security scheme can be further enhanced by other techniques or modifications. In one such modification one of the items in the user's profile could be a cellular telephone number. Then, if the cloud services trust module 272 detects a suspicious login situation it could break all connections and send a text message to the authorized user's cellular telephone providing a code word to enter to reestablish a secure connection.

C. CAP System Applications

It will be appreciated that the CAP system described herein can be adapted to provide a variety of advantages to users of multiple devices. One such example has been described above, in which operating system settings such as desktop wallpaper, language preferences, and accessibility options can be synchronized on multiple devices and thus roam from one device to another, so that changes made locally on one device would propagate to other devices belonging to the same account.

As noted above, the credential vault 224 in the trust module 222 stores user credentials. In one application user credentials are treated as a setting to be roamed to other connected devices or accounts. This is depicted in FIG. 2 by the arrows indicating that information is transferred between the settings synchronization module 226 and the credential vault in the operating system layer. As a more specific example, consider a user who has an account with a Web-based service such as Facebook. When the user enters his or her account information at the service's website, the user account creation/management module 212 causes the Web browser on the computing device to prompt the user to store these account credentials on the computing device, where they are placed in the credential vault 224. Through the settings synchronization module 226, the settings synchronization handler module 248, and the synchronization framework module 268, those account credentials become part of the user profile stored in the user profile module 266 in the cloud services layer. Then, when the user logs on to another trusted, device and enters his login credentials, the Web-based service account credentials are downloaded, to the credential vault of the other device. Then, when the user logs on to the Web-based service account from that device, the user does not have to enter those account credentials to access the account, even if it is the first time the user has used the other device.

Another application would permit authentication with all connected devices in an account at login on any one of the devices. Taking as an example an account that includes multiple personal computers in which the operating system module 104 includes a Microsoft Windows® operating system, a user will be able to log in to his or her computer using accounts from any participating online service, such as Microsoft Live® services, Google, Yahoo, to name a few. The provider of this type of service (that is, Microsoft, Google, Yahoo, etc.) could have its own CAP client software and CAP cloud services with which the user's operating system layer communicates, or a single CAP system could authenticate a user to numerous such online services. The user's account information (that is, username and password) for those services can be roamed to all of the user's trusted devices as discussed above, so that he or she would have access to the service from all such devices.

Another example is that a user can roam his or her personal information among several devices in a connected account. In this application personal information associated with the user's online account, such as a user tile icon that represents the user (say a photograph, for example), display name, e-mail address, to name a few) will synchronize among connected, devices. In this fashion, changes made online or locally on a connected device would propagate to other devices. Changes made locally on a device such as the computer system 100 shown in FIG. 1. In that case, the personal information would, be uploaded to the CAP cloud layer and other trusted devices of the user, as discussed above. The user could also access and change this personal account directly on the cloud through a Web browser. The information thus entered by the user would be synchronized with all other trusted devices as already discussed.

A further example would enable roaming of other device and network information. For example, if a user has installed peripheral hardware such as a printer or webcam on a personal computer, he or she will be able to set up and remotely use such hardware from other personal computers connected via the same account. This application would be useful for users who take laptop computers to different locations with different wireless networks. Many such wireless networks require user credentials for access, and by the methods discussed above, the credentials for all such wireless networks, once entered, would be stored in the laptop's credential vault 224 and in the user profile module 264 in the cloud services layer 260. Then, if the user gets a new laptop, or has more than one laptop or other device that he or she uses with these wireless networks, the credentials are automatically downloaded for storage in the credentials vault 224 of the other devices.

It will be seen that this feature can be used to make peripheral hardware, such as printers, more readily accessible to multiple devices of a user. For example, printers or scanners usually require drivers unique to each. Printer and scanner drivers could be one of the settings that is synchronized among numerous devices using the system shown in FIG. 2.

As a final example, devices in connected accounts will be able to remotely access content on homegroups to which they belong. HomeGroup is a feature of Microsoft Windows 7® operating system whereby a group of computers share files, photographs, etc., with all other computers in the same homegroup. To join a homegroup, a user must have the homegroup's password. The above system can automatically synchronize a new computer using the methods discussed above.

D. Summary

As will be apparent from the above description, the connected account provider system described herein provides a user-friendly manner of creating a user account that can be applied across different devices. An account is set up on one device and settings are saved in the cloud. A user can obtain secure access to the saved settings using a second (or subsequent) device and have selected settings synchronized to the second device. The system is realized in a preferred embodiment by client account provider software that is installed on the user devices in an architecture that creates a CAP client layer conceptually separate from the device's operating system. The CAP client software provides extension points for facilitating connection between connected devices' operating systems and a cloud services layer typically provided by the CAP client software provider.

Unless specifically stated, the methods described herein are not constrained to a particular order or sequence. In addition, some of the described method steps can occur or be performed concurrently. Further, the word “example” is used herein simply to describe one manner of implementation. Such an implementation is not to be construed as the only manner of implementing any particular feature of the subject matter discussed herein. Also, functions described herein as being performed by computer programs are not limited to implementation by any specific embodiments of such programs.

Although the subject matter herein has been described in language specific to structural features and/or methodological acts, it is to be understood that the subject matter of the appended claims is not limited to the specific features or acts described above. Rather, such features and acts are disclosed as sample forms of corresponding subject matter covered by the appended claims.

What is claimed is:

1. An electronic device comprising:
an operating system module stored on a storage medium and including software with executable instructions and a settings module for storing settings comprising information relating to operational properties of the device;
an input component for enabling a user to input commands for directing said operating system module to execute said instructions; and
a connected account provider client software module for enabling said operating system module to communicate with a remote site separate from said device in response to a user command and including a user profile module for storing one or more of said settings selected by the user, wherein said client software module includes a settings synchronization handler module for communicating settings stored in said settings module to said user profile module and for communicating at least some of said settings stored in said user profile module to said settings module of another said electronic device.

2. A device as in claim 1, wherein:
said settings include user credentials comprising first and second user information for uniquely identifying the user to said device; and
said settings module includes a trust module for enabling said device to display on a display component of said device a prompt for a user to input said second user information after said device has recognized said first user information.

3. A device as in claim 2, wherein;
said client software module includes a trust broker module for communicating information relating to said user credentials between said device and said remote site; and
information communicated from said remote site to said trust broker module causes said trust module to display said prompt.

4. A device as in claim 2, wherein said settings further include operational information selected from the group comprising a wallpaper displayed as a background on said display component, the choice and placement on said display component of icons and other components of a graphical user interface with which the user interacts using said input component to control the operation of the computer system, accessibility options the user has chosen, a list of software applications installed on said storage medium, usernames and passwords for various web sites and/or software applications, software associated with the operation of peripheral devices, custom spell-check dictionaries, video game information, and video player progress or status.

5. A device as in claim 1, wherein said operating system module includes a user account creation module for communicating with said remote site to download therefrom a user interface for display on a display component of said device, said interface permitting said user to enter user credentials uniquely identifying the user for storage in said settings module and in said user profile module.

6. A system as in claim 1, wherein the user can designate said other device to receive all of said settings stored in said user profile module or to receive only predetermined said settings stored in said user profile module.

7. A system for synchronizing information from one electronic device to another electronic device, the system comprising:
a remote site separate from said devices and including a user profile module for storing one or more settings comprising information relating to operational properties of said first device and a synchronization framework module for communicating information relating to said settings between said remote site and said devices; and
client software for installation on a connected account provider client software module of a first electronic device including (i) an operating system module stored on a storage medium and including software with executable instructions and a settings module for storing said settings, and (ii) an input component for enabling a user to input commands for directing said operating system module to execute said instructions, said client software installed on said first device provides a connected account provider client software module for enabling said operating system module of said first device to communicate with said remote site in response to a user command, wherein said client software module of said first device includes a settings synchronization handler module for communicating said settings stored in said settings module of said first device to said user profile module,
said client software being installable on a second electronic device including (i) an operating system module stored on a storage medium and including software with executable instructions and a settings module for storing said settings, and (ii) an input component for enabling a user to input commands for directing said operating system module to execute said instructions, said client software installed on said second device provides a connected account provider client software module for enabling said operating system module of said second device to communicate with said remote site in response to a user command, wherein said client software module of said second device includes a settings synchronization handler module for communicating at least some of said settings stored in said user profile module to said settings module of said second electronic device.

8. A system as in claim 7, wherein:
said settings include user credentials comprising first and second user information for uniquely identifying the user to said device; and
said settings module of each of said first and second device includes a trust module for enabling at least one of said devices to display on a display component of said device a prompt for a user to input said second user information after said device has recognized said first user information.

9. A system as in claim 8, wherein;
said client software module of each said device includes a trust broker module for communicating information relating to said user credentials between said respective device and said remote site; and
said remote site includes a remote site trust module for storing said first and second user information; and
said information from said remote site trust relating to said user credentials includes instructions to said client software trust broker module in at least one of said devices to cause said device trust module to display said prompt.

10. A system as in claim 8, wherein said settings further include operational information selected from the group comprising a wallpaper displayed as a background on said display component, the choice and placement on said display component of icons and other components of a graphical user interface with which the user interacts using said input component to control the operation of the computer system, accessibility options the user has chosen, a list of software applications installed on said storage medium, usernames and passwords for various web sites and/or software applications, custom spell-check dictionaries, video game information, and video player progress or status.

11. A system as in claim 10, wherein the user can designate said second device to receive all of said settings stored in said user profile module or to receive only predetermined said settings stored in said user profile module.

12. A system as in claim 7, wherein said operating system module of said first device includes a user account creation module for communicating with said remote site to download therefrom a user interface for display on a display component of said device, said interface permitting said user to enter user credentials uniquely identifying the user for storage in said settings module and in said user profile module.

13. A system as in claim 7, each said device includes Interne browser software for accessing said remote site.

14. A client account provider system for creating a connected user account available to plural electronic devices, the system comprising:
a remote site separate from said devices and including a user profile module thr storing one or more settings comprising information relating to operational properties of a first said first device and a synchronization framework module for communicating information relating to said settings between said remote site and said devices;
connected account provider client software for installation on each said device as a client software module for enabling communicate between said remote site and an operating system module of said device having software with executable instructions and a settings module for storing said settings of each said device in response to a user command received by said operating system module from an input component of said device, wherein said client software module includes a settings synchronization handler module for communicating settings stored in said device settings module to said remote site user profile module and for communicating at least some of said settings stored in said remote site user profile module to said device setting module of another said electronic device.

15. A system as in claim 14, wherein:
said settings include user credentials comprising first and second user information for uniquely identifying the user to said device; and
said settings module of each of said device includes a trust module for enabling at said device to display on a display component of said device a prompt for a user to input said second user information idler said device has recognized said first user information.

16. A system as in claim 15, wherein said settings further include operational information selected from the group comprising a wallpaper displayed as a background on said display component, the choice and placement on said display component of icons and other components of a graphical user interface with which the user interacts using said input component to control the operation of the computer system, accessibility options the user has chosen, a list of software applications installed on said storage medium, usernames and passwords for various web sites and/or software applications, custom spell-check dictionaries, video game information, and video player progress or status.

17. A system as in claim 14, wherein said remote site is maintained by a vendor of said connected account provider client software.

18. A system as in claim 17, wherein said operating system software is provided by said vendor of said connected account provider client software.

19. A system as in claim 14, each said device includes Internet browser software for accessing said remote site.

20. A system as in claim 14, wherein the user can designate said other device to receive all of said settings stored in said user profile module or to receive only predetermined said settings stored in said user profile module.
